(19) United States
(12) Patent Application Publication
(10) Pub. No.: US 2010/0076806 A1
(43) Pub. Date: Mar. 25, 2010

(54) Inventory management tool using a criticality measure

(75) Inventors: Anthony J. Grichnik, Peoria, IL (US); Gordon Duncan Ferguson, Peoria, IL (US); Arthur J. Stack, Melbourne (AU); Brian Dara Byrne, Poway, CA (US); Brian E. Beer, Yorkville, IL (US); Thomas Eugene Stoner, Peoria, IL (US); Terry Shan Livingston, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Solar Turbines Incorporated

(21) Appl. No.: 12/284,739

(22) Filed: Sep. 25, 2008

(51) Int. Cl. G06Q 10/00

(52) U.S. Cl. 705/8; 705/28; 705/29

(57) ABSTRACT

A computer system for an inventory management tool using a criticality measure is disclosed. The computer system has a memory, at least one input device, and a central processing unit in communication with the memory and the at least one input device. The central processing unit calculates an amount of existing inventory for one or more parts used to produce a product and determines a lead time to receive the one or more parts. The central processing unit also determines a build time to produce the parts into the product and receives a criticality measure for the product, the criticality measure indicating an order time for delivering the product. Further, the central processing unit adjusts a supply chain process for the parts based on the lead time, the build time, and the criticality measure.

### TECHNICAL FIELD

The present disclosure is directed to the field of inventory management and, more particularly, to an inventory management tool using a criticality measure.

### BACKGROUND

Businesses that sell products must maintain an adequate, but not excessive, inventory of the parts used to assemble products. The inventory must be adequate to serve the day to day needs of customers such that products can be provided in a timely fashion when needed. Customers expect that a business keeps certain products in inventory for same-day purchase and, if the business does not have the product in inventory, the customer may choose another vendor. In contrast, some products are special order items that customers infrequently purchase. Maintaining an inventory of parts used to create these special order products wastes space and consumes resources. As a result, businesses must balance the need to promptly serve their customers, while managing the costs associated with maintaining an inventory.

One field in which businesses must balance inventory needs is vehicle repair and servicing. A business that supplies original equipment products, maintenance products, and replacement products for a vehicle must manage inventory of parts used to assemble the products. Inventory needs can be predicted, for example, using a maintenance schedule from the company that manufactured the vehicle. Historical transaction data can also be used to predict inventory needs. For example, a business may maintain an adequate inventory of parts needed to assemble a mining truck within a timeframe acceptable to a customer who purchases the mining truck. Some parts needed to assemble the mining truck may be readily obtained from a supplier, while other parts may be a special order item that may not be available within the timeframe required by a customer. The business should maintain a balance of parts based not only on the timeframe for assembling a product, but also based on the amount of time required to obtain the parts needed to assemble the product.

One tool that has been developed for managing inventory is U.S. Pat. No. 7,058,587 to Horne (the '587 patent). The '587 patent describes a tool that allocates the supply of critical components and manufacturing capacity. The '587 patent substitutes components in assemblies when there is insufficient availability of a primary component and insufficient lead-time to acquire it. Parts are classified into various groups according to dollar value to balance inventory needs. By substituting components based on lead-time and cost, the '587 patent manages manufacturing capacity to ensure that all materials necessary for production are available.

Although the tool of the '587 patent may manage a manufacturer's inventory based on component availability and cost, it fails to account for the unique demands of a customer. In particular, it fails to account for the criticality of a product to a customer. For example, a customer purchasing a new mining truck may be willing to wait longer for the mining truck to reduce costs because the customer may already own numerous mining trucks. As a result, a manufacturer of the mining truck can accept longer lead times and lower inventory for parts used to assemble the mining truck, reducing operating costs. In contrast, a customer may request a product that is critical to operating the customer's business, such as a mining shovel when the customer only owns a small number of mining shovels to supply mining trucks. A delay in obtaining a replacement mining shovel component may reduce a customer's income substantially, making the product critical to the customer's business. The tool of the '587 patent fails to account for the criticality of a customer receiving a product for a more critical asset in a timely fashion. Accordingly, the '587 patent fails to balance inventory in a way that both maximizes the efficiency of a manufacturer and accounts for customer needs. Moreover, increasing inventory to ensure components are available to build a product in a timely fashion or increasing production capacity to build a product more quickly once the components may also effect the lead time in delivering a product to a consumer. However, maintaining excessive inventory and/or maintaining excessive personnel to build products is inefficient and may waste resources.

The present disclosure is directed to overcoming one or more of the problems set forth above.

### SUMMARY

In accordance with one aspect, the present disclosure is directed toward a computer readable medium, tangibly embodied, including an supply chain process management tool with a criticality measure. The computer readable medium includes instructions for calculating an amount of existing inventory for one or more parts used to produce a product and determining a lead time to receive the one or more parts. The computer readable medium also includes instructions for determining a build time to produce the parts into the product and receiving a criticality measure for the product, the criticality measure indicating an order time for delivering the product. Further, the computer readable medium includes instructions for adjusting a supply chain process for the parts based on the lead time, the build time, and the criticality measure.

According to another aspect, the present disclosure is directed toward a method for providing an inventory management tool using a criticality measure. The method includes calculating an amount of existing inventory for one or more parts used to produce a product and determining a lead time to receive the one or more parts. The method may also include determining a build time to produce the parts into the product and receiving a criticality measure for the product, the criticality measure indicating an order time for delivering the product. Further, the method may include adjusting a supply chain process for the parts based on the lead time, the build time, and the criticality measure.

According to another aspect, the present disclosure is directed to a computer system including a memory, at least one input device, and a central processing unit in communication with the memory and the at least one input device. The central processing unit calculates an amount of existing inventory for one or more parts used to produce a product and determines a lead time to receive the one or more parts. The central processing unit also determines a build time to produce the parts into the product and receives a criticality measure for the product, the criticality measure indicating an order time for delivering the product. Further, the central processing unit adjusts a supply chain process for the parts based on the lead time, the build time, and the criticality measure.

### BRIEF DESCRIPTION OF THE DRAWINGS

FIG. 1 is a block illustration of an exemplary disclosed inventory management system using a criticality measure.

FIG. 2 is a flowchart illustration of an exemplary disclosed method of managing inventory using a criticality measure

### DETAILED DESCRIPTION

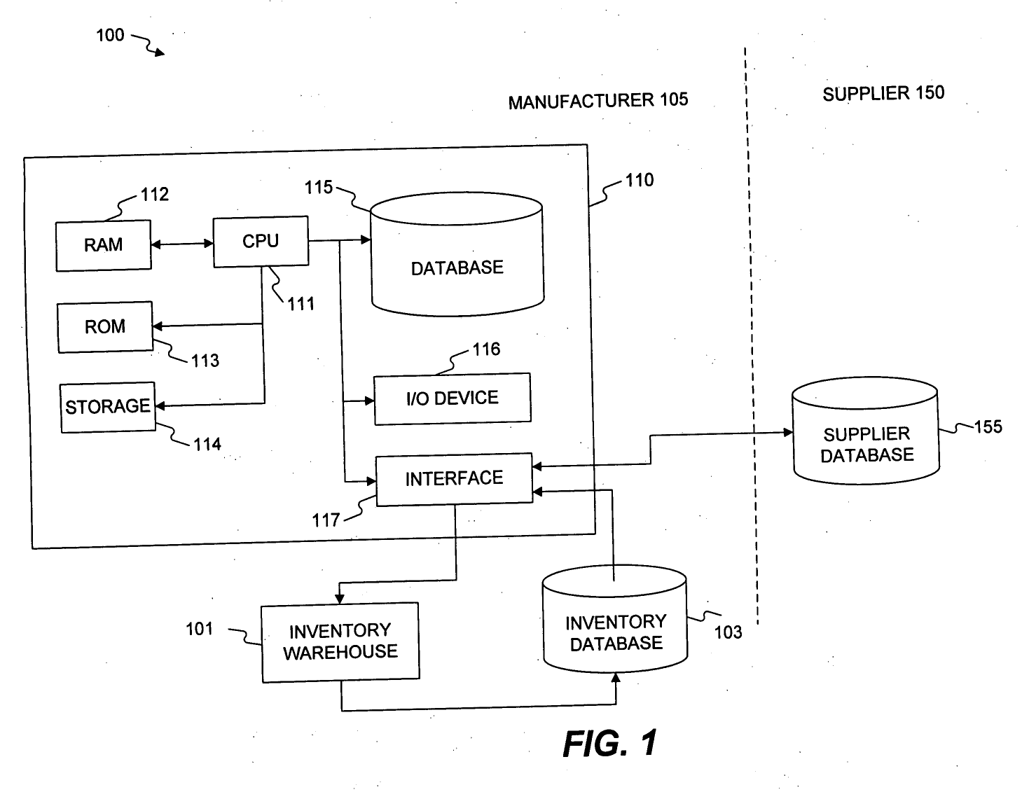

FIG. 1 provides a block diagram illustrating an exemplary disclosed inventory environment 100. Inventory environment 100 may include any type of environment associated with monitoring and managing an inventory. For example, inventory environment 100 may include a part warehouse configured to receive and assemble parts into one or more products. As used herein, the term “part” may refer to a portion into which a product is divided, including any material and/or subassembly. A product may be a good that is sold to a customer. For example, if a customer desires to purchase a vehicle, the vehicle may include a plurality of “parts,” such as an engine, fuel system, tires, wheels, a transmission, or any other suitable component of the vehicle. If a customer desires to purchase an engine, the engine may be assembled from one or more parts, such as an oil filter, pistons, rods, and a crankshaft. Similarly, pistons may be assembled from one or more parts, and so on through a supply chain.

Inventory environment 100 may include a manufacturer 105 and supplier 150. Manufacturer 105 may include, among other things, an inventory warehouse 101 containing a plurality of parts and products, an inventory database 103, and a system 110 for maintaining inventory records. Supplier 150 may include a supplier database 155. Although illustrated as a single manufacturer 105 and a single supplier 150, a plurality of manufacturers 105 may be connected to either a single, centralized supplier 150 or a plurality of distributed suppliers 150. Moreover, one or more customers that purchase products may be connected to manufacturer 105 and supplier 150.

Inventory warehouse 101 may include any type of facility for storing a plurality of parts and products. Inventory warehouse 101 may include, for example, a parts depot, a product showroom, a document storage facility, or any other type of facility suitable for storing products and parts. Inventory warehouse 101 may also include, for example, a manufacturing facility for assembling parts into products.

Inventory database 103 may include any type of electronic data storage device that may store data. Inventory database 103 may contain one or more inventory records associated with each of the plurality of parts stored within inventory warehouse 101. Inventory database 103 may constitute a standalone computer system that includes one or more computer programs for monitoring and maintaining inventory records associated with inventory warehouse 101. Inventory database 103 may also be integrated as part of an inventory warehouse computer or system 110 for maintaining inventory records. It is also contemplated that inventory database 103 may include a shared database between one or more computer systems of business entities associated with inventory warehouse 101, such as an accounting division, a sales division, a supplier, or any other appropriate business entity that may deal with inventory warehouse 101.

System 110 may include any type of processor-based system on which processes and methods consistent with the disclosed embodiments may be implemented. For example, as illustrated in FIG. 1, system 110 may include one or more hardware and/or software components configured to execute software programs. System 110 may include one or more hardware components such as a central processing unit (CPU) 111, a random access memory (RAM) module 112, a read-only memory (ROM) module 113, a storage 114, a database 115, one or more input/output (I/O) devices 116, and an interface 117. System 110 may include one or more software components such as a computer-readable medium including computer-executable instructions for performing methods consistent with certain disclosed embodiments. One or more of the hardware components listed above may be implemented using software. For example, storage 114 may include a software partition associated with one or more other hardware components of system 110. System 110 may include additional, fewer, and/or different components than those listed above, as the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and CPU 111. RAM 112 may include a memory device for storing data associated with one or more operations of CPU 111. For example, ROM 113 may load instructions into RAM 112 for execution by CPU 111. ROM 113 may include a memory device configured to access and store information associated with system. 110, including information for identifying, initializing, and monitoring the operation of one or more components and subsystems of system 110.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and CPU 111. For example, database 115 may include historical data, such as previous adjustments to inventory records based on physical count data, previous demand by customers for parts and products, criticality measures indicating an acceptable order time for delivering a product, lead time in obtaining parts used to assemble products, data indicating a build time for assembling parts into products, and/or previous inventory records. CPU 111 may access the information stored in database 115 for comparing the physical count data with the inventory record data to determine whether an adjustment to the inventory record may be required, as described below. CPU 111 may also analyze current and previous inventory count records to identify trends in inventory count adjustment.

I/O devices 116 may include one or more components configured to communicate information with a user associated with system 110. For example, I/O devices may include a console with an integrated keyboard and mouse to allow a user to input parameters associated with system 110. I/O devices 116 may also include a display, such as a monitor, including a graphical user interface (GUI) for outputting information. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device. Although not illustrated, inventory warehouse 101, inventory database 103, and supplier database 155 may also include I/O devices that allow user interaction.

The results of received data may be provided as output from system 110 to I/O device 116 for printed display, viewing, and/or further communication to other system devices. Such output may include, for example, current inventory levels, projected inventory requirements, recommended inventory levels, and order forms to obtain additional inventory. Output from system 110 can also be provided to database 115 and to supplier database 155 to track historical inventory, recommended inventory levels, and demand for parts and products. Using this information, inventory environment 100 may analyze whether a recommended inventory level was appropriate and account for the unique demands of manufacturer 105 and customers.

Interface 117 may include one or more components configured to transmit and receive data via a communication network, such as the Internet, a local area network, a workstation peer-to-peer network, a direct link network, a wireless network, or any other suitable communication platform. In this manner, inventory warehouse 101, inventory database 103, system 110, and supplier database 155 may communicate through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

System 110 may monitor and manage inventory records, including transactions, part and product distribution, or other changes in inventory such as surpluses and deficits uncovered during physical counts. System 110 may periodically or continuously monitor the data in inventory database 103 and generate recommended quantities of parts to maintain in inventory warehouse 101. The recommended quantities may be provided by system 110 using one or more reports. Additionally, system 110 may update, store, modify, or analyze data associated with inventory database 103 based on actual inventory quantities derived from physical count data.

System 110 may also monitor the needs of customers and form criticality measures indicating an acceptable order time for a product. For example, a customer may indicate to manufacturer 105 whether a product must be received on the same day, within one week, within one month, or within six months, although any time frame may be specified by a customer. The criticality measure may be developed by a customer prior to ordering a product, such that manufacturer 105 may maintain adequate inventory to satisfy future customer needs. System 110 may also track historical data indicating the products that were sold and the parts that were used to service customer products. For example, system 110 may store the vehicle identification number, mileage, and product configuration (e.g., engine, transmission, and trim level) for a customer. The age, mileage, repair history, and other information may be stored for each product that system 110 monitors, along with the sales, historical, and transient data, in database 115. This information may then be used to generate recommended inventory quantities. Further, criticality measures from multiple customers may be combined to produce an overall criticality measure that describes a component's criticality to a company's overall business with of its customers.

Supplier 150 may be associated with a manufacturer, supplier, or distributor of one or more parts that are used by manufacturer 105 to assemble products. For example, if manufacturer 105 offers maintenance and repair of vehicles, supplier 150 may provide manufacturer 105 with pistons, rods, and a crankshaft that manufacturer 105 may assemble into an engine.

Supplier database 155 may provide information to manufacturer 105 that manufacturer 105 may use to manage inventory, including generating recommendation inventory quantities. Such information may be, for example, part listings with part descriptions, part numbers, information on which part can be remanufactured, part updates, part maintenance and repair schedules, historical usage data indicating repair intervals from customers, a lead time for delivering each part to manufacturer 105 after receiving an order, and existing and projected part inventories that supplier 150 has available.

Those skilled in the art will appreciate that all or part of systems and methods consistent with the present disclosure may be stored on or read from other computer-readable media. Inventory environment 100 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) 113 or random-access memory (RAM) 112. Such computer-readable media may be embodied by one or more components of inventory environment 100, such as inventory database 103, CPU 111, storage 113, database 115, supplier database 155, or combinations of these and other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The described implementation may include a particular network configuration but embodiments of the present disclosure may be implemented in a variety of data communication network environments using software, hardware, or a combination of hardware and software to provide the processing functions.

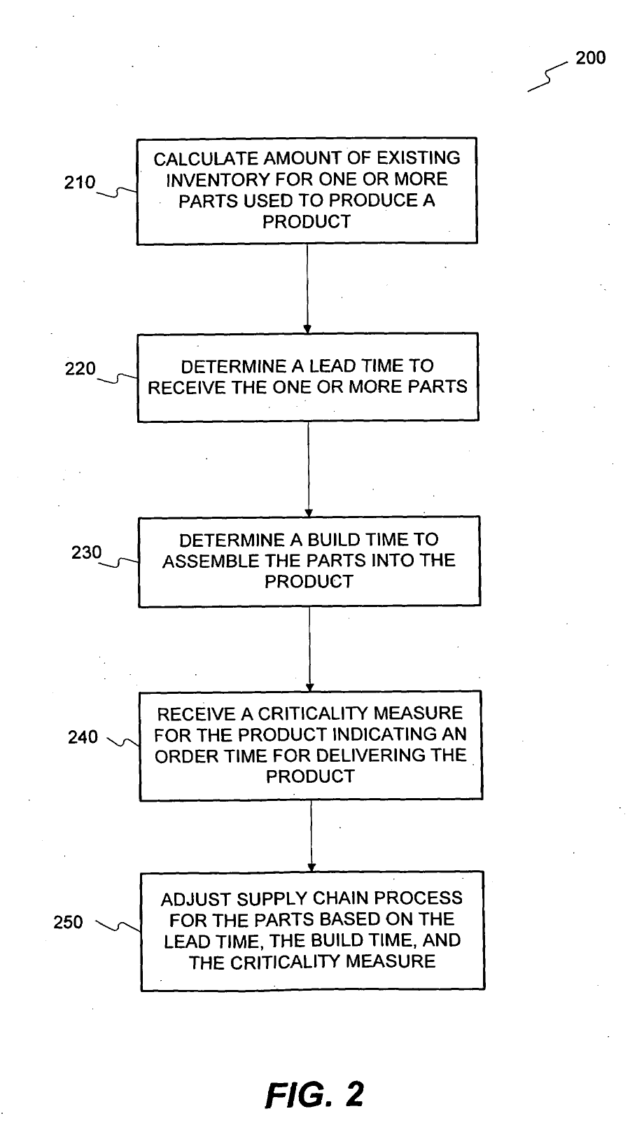

Processes and methods consistent with the disclosed embodiments may provide inventory control processes that reduce the potential for losing customers due to lack of sufficient inventory and that reduce costs associated with maintaining excessive inventory. As a result, inventory may be managed and recommended inventory quantities may be generated, allowing a manufacturer to maintain sufficient quantities of parts that may be used to assemble products for customers within an acceptable period of time. Exemplary processes and methods consistent with the invention will now be described with reference to FIG. 2.

### INDUSTRIAL APPLICABILITY

The disclosed method and system may provide an inventory management tool using a criticality measure. In particular, the disclosed method and system may be used to implement an inventory management and recommendation tool that considers manufacturer, supplier, and customer factors. Recommendations for inventory may be provided in a variety of manners, such as with a minimum and maximum quantity, allowing easy comparison to current quantities in inventory warehouse 101 In this manner, a manufacturer may monitor and maintain adequate inventory levels to build products for customers within an acceptable period of time.

As illustrated in FIG. 2, the first step in the functioning of the inventory management tool using a criticality measure may include calculating an existing inventory for one or more parts used to produce a product (Step 210). The calculating may include a physical count using, for example, a hand-held bar-code scanner, an electronic count using inventory database 103, or any other method for calculating an existing inventory of parts.

The inventory of parts may be replenished according to a variety of techniques and categories. For example, some parts may be categorized as easy to store and relatively inexpensive, such as nuts, bolts, and washers. This category of parts may include, for example, approximately 90% of the parts required to produce a product, but only a small percentage (e.g., 5%) of the assembly cost. Manufacturer 105 may choose to maintain a slight surplus of these parts because of the low cost of maintaining inventory. By having a slight surplus, the manufacturer ensures that assembly of a product will not be delayed due to insufficient quantity of parts that could have readily been stored in inventory warehouse 101.

Another category of parts may include parts that are expensive to maintain in inventory due to cost and/or space requirements. These parts may initially be maintained in smaller quantities. Upon receiving an order for a product, manufacturer 105 may order the product for use in production. However, simply ordering parts upon receipt of an order may leave manufacturer 105 unable to produce the product within the timeframe requested by a customer.

Manufacturer 105 may also store existing inventory based on a replenishment—as parts are used, more parts are ordered from supplier 150. Manufacturer 105 may also employ forecasting techniques based on historical usage data for parts to determine when and how much inventory to request from supplier 150. Other inventory replenishment methods may also be utilized by manufacturer 105 to maintain an adequate inventory level. However, to address the responsiveness needs of a customer while avoiding storage of excessive inventory, manufacturer 105 may modify inventory levels based on a criticality measure, as discussed below.

Next, manufacturer 105 may determine a lead time to receive the one or more parts from supplier 150 (Step 220). Manufacturer 105 may contact supplier 150 periodically to determine the lead time for obtaining parts based on the existing inventory of supplier 150. Manufacturer 105 may also be directly connected to an inventory management system for supplier 150 to allow instant determination of a lead time for each part. Further, manufacturer 105 may identify different suppliers that can provide the same or similar parts with different lead times. For example, an overseas supplier 150 who is located overseas may be able to supply a part at a low cost, but with a longer lead time compared to a domestic supplier 150. By identifying a plurality of suppliers, costs for parts from each supplier, and lead times for obtaining the parts, manufacturer 105 can determine how much time is required to obtain parts needed to produce a product.

Manufacturer 105 may then determine a build time to assemble the parts into the product (Step 230). Manufacturer 105 may determine the build time based on historical data, current and projected demand for manufacturing products, whether additional resources are available for a rush order (e.g., whether employees can work overtime), and based on any other factor that affects a build time for assembling a product. The build time may include testing of a product before shipping the product to a customer, as well as the projected shipping time for delivery.

Next, manufacturer 105 may receive a criticality measure for the product indicating an order time for delivering the product to a customer. Order times may be exact dates (e.g., deliver on Mar. 23, 2008), or ranges of dates (e.g., deliver within the next week, month, or six months). Customers may indicate criticality measures for products that they may order in the future. The criticality measure may identify the importance of obtaining the product within a given time frame.

For example, products that are critical to the operation of a customer's business may receive a high criticality measure. An example of a high criticality measure product is a pipelayer for a company in the pipelaying business with a low quantity of pipelayers. That is, a company that only owns one or two pipelayers may indicate that the pipelayer has a high criticality measure, because the company is unable to operate when one of their pipelayers fails.

Other products may have a medium criticality measure. For example, the same pipelaying company may own enough bulldozers that all of their needs are met, but they are operating near capacity. If the company has enough bulldozers that failure of one bulldozer would not substantially affect their business, such as when a delay would be acceptable or when a bulldozer from another job site can be used, the bulldozer may have a medium criticality measure. As another example, a large company with numerous pipelayers may identify a pipelayer as a medium criticality. In this manner, each customer may identify criticality measures for each product according to the customer's various needs.

Another criticality measure may be low. Products having low criticality measure may include products that a customer is willing to wait the longest period of time before obtaining. For example, a customer may order routine maintenance products well in advance of the date the product needs to be replaced.

Although three exemplary criticality measures have been described, a customer may develop different criticality measures particular to the customer's needs. A customer with a sophisticated inventory management system may prefer a criticality scale of 0-100 to further divide the classification of products. In general, as a customer indicates a product is less critical, manufacturer 105 may maintain lower inventories for the parts used to assemble less critical products. As a result, manufacturer 105 may reduce costs associated with maintaining inventory and/or select a supplier 150 based on costs rather than only lead time. In contrast, manufacturer 105 may maintain ample inventory of parts used to assemble products with a high criticality measure or, in the event manufacturer 105 does not have adequate inventory to assemble a highly critical product, manufacturer 105 may select a supplier 150 with the shortest lead time.

Next, manufacturer 105 may adjust a supply chain process for parts based on the lead time, the build time, and the criticality measure (Step 250). For example, assume that a customer requests a product within seven days, where the build time for the product is five days, and the lead time to obtain parts needed to build the product is four days. In this example, manufacturer 105 must maintain in inventory the parts needed to assemble the product to satisfy the customer's order time because the build time plus the lead time exceeds to the order time (e.g., 5+4>7). Once system 110 detects a situation where the lead time cannot be met, system 110 may increase inventory levels (to accommodate the total of lead time+build time), decrease build time (such as by adding more production capacity to existing processes), or reduce the lead time (such as by selecting one or more supplies that have lower transport time). The inventory levels, build times, and lead times may be reduced at any point in a supply chain. For example, a manufacturer of an engine may that obtains pistons for use in producing the engine request that the manufacturer of the pistons increase their inventory of parts used to produce the pistons. In this manner, the pistons may be supplied to the engine manufacturer faster, decreasing the lead time and allowing the engine manufacturer to meet the order time of a customer. Based on the updated supply chain, system 110 may calculate an overall time needed to produce the product (e.g., lead time+build time). Additional techniques may also be used to meet lead times requested by customers, such as those described in U.S. Patent Application Publication No. 2007/0150332 to Grichnik et al.

However, if a customer requests a product with an order time of six months that has a build time of two weeks with all of the parts having a lead time of two months, manufacturer 105 has ample time to fulfill the requested order time. In this example, manufacturer 105 may seek alternative suppliers for parts that may have longer lead times, but lower costs.

Many products may involve a combination of parts that must be maintained in inventory versus parts that can be ordered as needed. Manufacturer 105 may modify the techniques discussed above (e.g., maintaining a surplus of inexpensive parts, ordering expensive parts on demand, and replenishing parts as used) based on the criticality measure for the products. In this manner, manufacturer 105 may account for the lead time required to obtain parts from supplier 150, the build time for assembling parts into a product, and the criticality measure to deliver the products within the order time requested by a customer.

Manufacturer 105 may also consider historical transaction data when determining how to modify existing inventory. For example, assume a customer identifies, in advance, that a product has a high criticality measure, but the product includes parts that are expensive to maintain in inventory. Further assume the customer only orders the product infrequently (e.g., every ten years), making the costs of maintaining inventory burdensome on manufacturer 105 given the prospective sale to the customer. In this situation, manufacturer 105 may negotiate with the customer for a longer order time, allowing parts to be obtained on demand to avoid wasteful inventory. Alternatively, manufacturer 105 may identify a second manufacturer capable of providing the product within the projected order time based on the criticality measure. The second manufacturer may specialize in building the particular product requested by a customer. In this example, manufacturer 105 may forward a product order to the second manufacturer, obtain the product within the order time, and collect a reduced fee for locating the product.

Customers may provide manufacturer 105 with orders for a product in any manner, such as by telephone, automatically at periodic intervals, or via the Internet. After receiving an order and assembling the product, manufacturer 105 may analyze the historical data for the build time to adjust inventory levels as needed. For example, if manufacturer 105 anticipated that the build time would be two weeks, but three weeks were required, the build time can be adjusted and an inventory analysis can be performed using the adjusted build time. Moreover, customers may alter criticality measures at any time by notifying manufacturer 105. For example, if a customer purchases four new pipelayers and their pipelaying business slows, the customer may reduce a criticality for a pipelayer from high to low.

The disclosed inventory management tool using a criticality measure balances the need for efficient inventory management by a manufacturer, while ensuring the demands of a customer can be met. In this manner, the disclosed inventory management tool using a criticality measure may provide improved inventory control by recommending an adequate, but not excessive, inventory.

It will be apparent to those skilled in the art that various modifications and variations can be made to the disclosed methods for managing inventory. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-readable medium comprising instructions which, when executed by a processor, perform a method for managing inventory, the method comprising:
calculating an amount of existing inventory for one or more parts used to assemble a product;
determining a lead time to receive the one or more parts;
determining a build time to assemble the parts into the product;
receiving a criticality measure for the product, the criticality measure indicating an order time for delivering the product; and
adjusting a supply chain process for the parts based on the lead time, the build time, and the criticality measure.

2. The computer-readable medium of claim 1, wherein the method further includes:
calculating an overall time needed to assemble the product based on the adjusted supply chain process.

3. The computer-readable medium of claim 1, wherein adjusting the supply chain process includes at least one of:
adjusting a production capacity of one or more elements in a supply chain; and
changing inventory levels at one or more points in the supply chain.

4. The computer-readable medium of claim 1, wherein the method further includes:
receiving an order for the product;
assembling the product; and
updating the inventory based on a measured build time.

5. The computer-readable medium of claim 1, wherein:
the criticality measure is received before receiving an order for the product, and
the criticality measure is updated after receiving the order.

6. The computer-readable medium of claim 1, wherein the method further includes:
receiving an order for the product;
determining that the inventory for the parts to assemble the product is insufficient based on the criticality measure;
identifying a supplier with a reduced lead time compared to the lead time, the reduced lead time satisfying the order time for the parts; and
obtaining the parts from the supplier.

7. The computer-readable medium of claim 1, further including:
increasing the inventory for parts used to assemble a product with a high criticality measure; and
reducing the inventory for parts used to assemble a product with a low criticality measure.

8. A method for managing inventory, comprising:
calculating an amount of existing inventory for one or more parts used to assemble a product;
determining a lead time to receive the one or more parts;
determining a build time to assemble the parts into the product;
receiving a criticality measure for the product, the criticality measure indicating an order time for delivering the product; and
adjusting a supply chain process for the parts based on the lead time, the build time, and the criticality measure.

9. The method of claim 8, further including:
calculating an overall time needed to assemble the product based on the adjusted supply chain process.

10. The method of claim 8, wherein adjusting the supply chain process includes at least one of:
adjusting a production capacity of one or more elements in a supply chain; and
changing inventory levels at one or more points in the supply chain.

11. The method of claim 8, further including:
receiving an order for the product;
assembling the product; and
updating the inventory based on a measured build time.

12. The method of claim 8, wherein:
the criticality measure is received before receiving an order for the product, and
the criticality measure is updated after receiving the order.

13. The method of claim 8, further including:
receiving an order for the product;
determining that the inventory for the parts to assemble the product is insufficient based on the criticality measure;
identifying a supplier with a reduced lead time compared to the lead time, the reduced lead time satisfying the order time for the parts; and
obtaining the parts from the supplier.

14. The method of claim 8, further including:
increasing the inventory for parts used to assemble a product with a high criticality measure; and
reducing the inventory for parts used to assemble a product with a low criticality measure.

15. A computer system, comprising:
a memory;
at least one input device; and
a central processing unit in communication with the memory and the at least one input device, wherein the central processing unit:
calculates an amount of existing inventory for one or more parts used to assemble a product;
determines a lead time to receive the one or more parts;
determines a build time to assemble the parts into the product;
receives a criticality measure for the product, the criticality measure indicating an order time for delivering the product; and
adjusts a supply chain process for the parts based on the lead time, the build time, and the criticality measure.

16. The computer system of claim 15, wherein the central processing unit further:
calculates an overall time needed to assemble the product based on the adjusted supply chain process.

17. The computer system of claim 15, wherein adjusting the supply chain process includes at least one of:
adjusting a production capacity of one or more elements in a supply chain; and
changing inventory levels at one or more points in a supply chain.

18. The computer system of claim 15, wherein the central processing unit further:
receives an order for the product;
assembles the product; and
updates the inventory based on a measured build time.

19. The computer system of claim 15, wherein the criticality measure is received before receiving an order for the product.

20. The computer system of claim 15, wherein the central processing unit further:
receives an order for the product;
determines that the inventory for the parts to assemble the product is insufficient based on the criticality measure;
identifies a supplier with a reduced lead time compared to the lead time, the reduced lead time satisfying the order time for the parts; and
obtains the parts from the supplier.
